(19) United States
(12) Patent Application Publication
(10) Pub. No.: US 2008/0177536 A1
(43) Pub. Date: Jul. 24, 2008

(54) A/V CONTENT EDITING

(75) Inventors: Adil Sherwani, Bellevue, WA (US); Christopher Weare, Bellevue, WA (US); Patrick Nguyen, Seattle, WA (US); Milind Mahajan, Redmond, WA (US); Alex Acero, Bellevue, WA (US); Manuel Clement, Bellevue, WA (US); Patrick Nelson, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/626,726

(22) Filed: Jan. 24, 2007

(51) Int. Cl. G10L 15/26

(52) U.S. Cl. 704/235; 704/E15.04

(57) ABSTRACT

A/V content creation, editing and publishing is disclosed. Speech recognition can be performed on the A/V content to identify words therein and form a transcript of the words. The transcript can be aligned with the associated A/V content and displayed to allow selective editing of the transcript and associated A/V content. Keywords and a summary for the transcript can also be identified for use in publishing the A/V content.

### BACKGROUND

Audio/Video (A/V) content production is becoming more and more a part of personal computing, mobile and Internet technology. A/V content occurs in various forms such as short A/V clips and regular A/V shows such as radio and television shows, movies, etc. In addition, A/V content occurs in what are referred to as “podcasts”, which are media files containing A/V content that are published over the Internet for download and/or streaming.

Creation and editing of A/V content itself can be a time-consuming and expensive process. Current technologies for creating and editing A/V content rely on techniques such as assigning user-specified metadata to sections of A/V content, manual or programmatic detection of regions of audio to serve as previews and/or displaying waveforms to allow a user to see relative loudness of various sections of audio. Efficient editing of A/V content requires knowing what the content is and where the content is in relation to other material for deleting, moving and/or manipulating.

Creation and publication of A/V content such that the full potential of A/V consumption is realized can also be time consuming. For instance, when a user searches the internet for textual results, there are often textual summaries generated for these results. The summaries allow a user to quickly gauge the relevance of the results. Even when there are no summaries, a user can quickly browse textual content to determine its relevance. Unlike text, A/V content can hardly be analyzed at a glance. Therefore, discovering new content, gauging the relevance of search results or browsing content, becomes difficult. Published A/V content can include associated metadata that aids in providing textual summaries for the A/V content, but this information is typically manually entered and can result in high costs of entry.

The discussion above is merely provided for general background information and is not intended to be used as an aid in determining the scope of the claimed subject matter the A/V content.

### SUMMARY

A/V content creation, editing and publishing is disclosed. Speech recognition can be performed on the A/V content to identify words therein and form a transcript of the words. The transcript can be aligned with the associated A/V content and displayed to allow selective editing of the transcript and associated A/V content. Keywords and a summary for the transcript can also be identified for use in publishing the A/V content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of an A/V content editing system.

FIG. 2 is a flow diagram of a method for separating audio content.

FIG. 3 is a flow diagram of a method for identifying and displaying words in a speech segment.

FIG. 4 is an exemplary user interface for displaying and editing A/V content.

FIG. 5 is a flow diagram of a method for editing A/V content,

FIG. 6 is an exemplary computing system environment.

### DETAILED DESCRIPTION

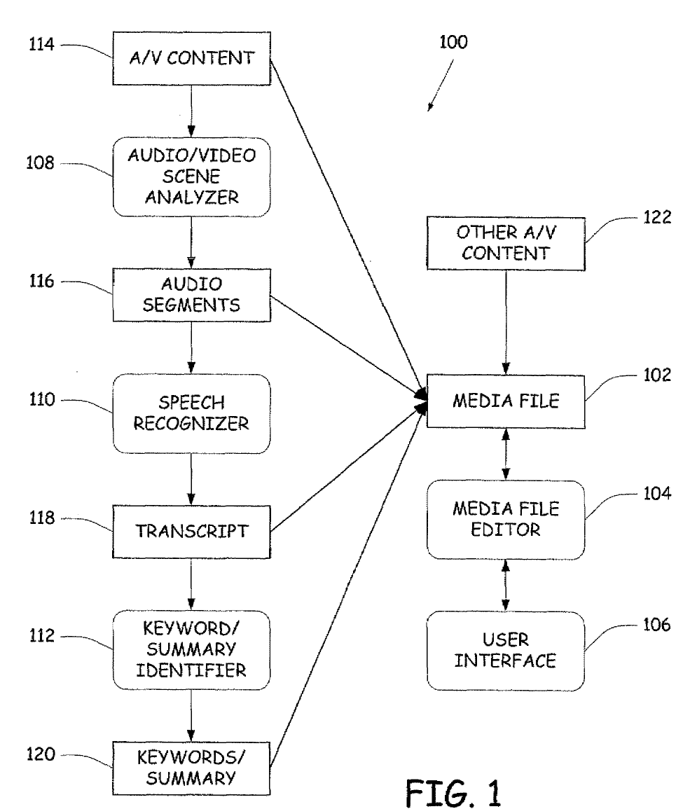

FIG. 1 is a block diagram of an A/V editing system 100 that is used to create a media file 102 through use of a media file editor 104 having a user interface 106. System 100 includes an audio scene analyzer 10S, a speech recognizer 110 and a keyword/summary identifier 112. A/V content 114 is provided to audio scene analyzer 108. In one example, a user may wish to create a media file 102 such as a podcast to be published via and consumed over a network such as the Internet. To create media file 102, the user can record A/V content 114 through various A/V recording devices such as a video camera, audio recorder, etc. Additionally, A/V content 114 can be recorded at a separate time and/or place to be accessed by system 100. It is noted that A/V content 114 can include audio and video data or just audio data such as that found in a radio show. Thus, as used herein, A/V content is to be interpreted as including audio without video or audio and video together.

Audio/video scene analyzer 108 analyzes A/V content 114 to identify separate audio segments 116 contained therein. Audio segments 116 can be labeled with a particular category or condition such as background music, speech, silence, noise, etc. If desired, audio/video scene analyzer 108 can also be used to determine boundaries for A/V content 114 that can be processed separately and in parallel to improve processing efficiency, for example, by using multiple processing elements, as discussed below.

The speech segments from audio segments 116 are sent to speech recognizer 110, which provides a transcript 118 of text from recognized words in each speech segment. Any type of speech recognizer can be used to recognize words within a speech segment. For example, speech recognizer 110 can include a feature extractor, acoustic model and language model to output a hypothesis of one or more words as to an intended word in a speech segment. The hypothesis can further include a confidence score as an indication of how likely a particular word was spoken. Speech recognizer also aligns words with its associated audio in the speech segment. During alignment, boundaries in the speech segment are identified for words contained therein.

A keyword/summary identifier 112 identifies keywords and a summary, collectively keywords/summary 120, from transcript 118. Various textual and natural language processing techniques can be used to generate keywords/summary 120 from transcript 118. Additionally, keywords/summary 120 can be provided for portions of transcript 118, such as chapters and/or scenes in A/V content 114.

A/V content 114 and audio segments 116, along with transcript 118 and keywords/summary 120, are stored in media file 102. Editor 104, through user interface 106, can edit A/V content 114, audio segments 116, transcript 118 and keywords/summary 120. Additionally, other A/V content 122 can be added to media file 102 as desired. Using user interface 106, a user can delete, move and/or otherwise manipulate this data. For example, a user can move a portion of the A/V content to another position, insert an alternative background music segment into audio segments 116, edit words from transcript 118 and/or alter keywords/summary 120. Additionally, other A/V content 122, such as advertisements and/or other A/V clips, can be inserted into a desired position within A/V content 114. Since transcript 118 is aligned with the A/V content 114, removing, editing and/or moving of words in the transcript can be used to modify the A/V content associated therewith.

Once media file 102 is complete, its contents can be published for consumption on a network such as the Internet for download and/or streaming. Several Internet applications can utilize information within media file 102 to enhance consumption of the A/V content therein. For example, transcript 118 and keywords/summary 120 can be exposed to search engines and/or advertising generators. Search engines can index this data to facilitate discovery of the A/V content. Thus, persons can easily search and view information in transcript 118 and keywords/summary 120 to find relevant A/V content for consumption. Advertising generators can also use this information to determine relevant advertisements to display while persons view and/or listen to A/V content 114.

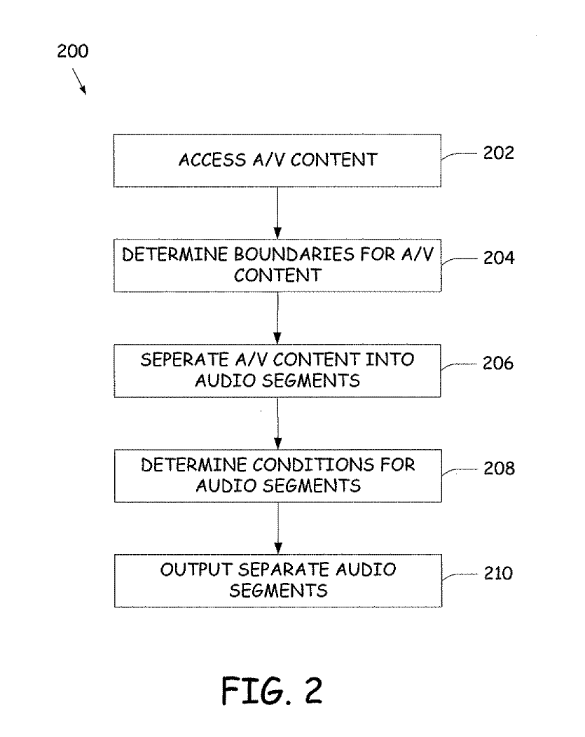

FIG. 2 is a method performed by audio/video scene analyzer 108 to process A/V content 114. At step 202, A/V content 114 is accessed. Within the A/V content, boundaries for the A/V content are determined at step 204. In one example, speech processing can be used to determine appropriate boundaries for which to break the A/V content into pieces. For example, long silences, signals that are improbable word patterns, etc. can be used as breakpoints in the A/V content. If desired, each portion of the audio content can be processed separately using multiple processing elements, for example by separate cores of a multi-core processor and/or by separate computers to reduce latency in processing the A/V content. The processing elements can process the speech segments in parallel. Processing elements can include computing devices, processors, cores within processors, and other elements that can be physically proximate or located remotely, as desired. At step 206, the A/V content is separated into audio segments. A condition for each of the audio segments is determined at step 208. For example, the conditions can be background music, noise, speech, silence, etc. At step 210, the separate audio segments are output. Thus, the speech segments can be sent to speech recognizer 110 to recognize words contained therein.

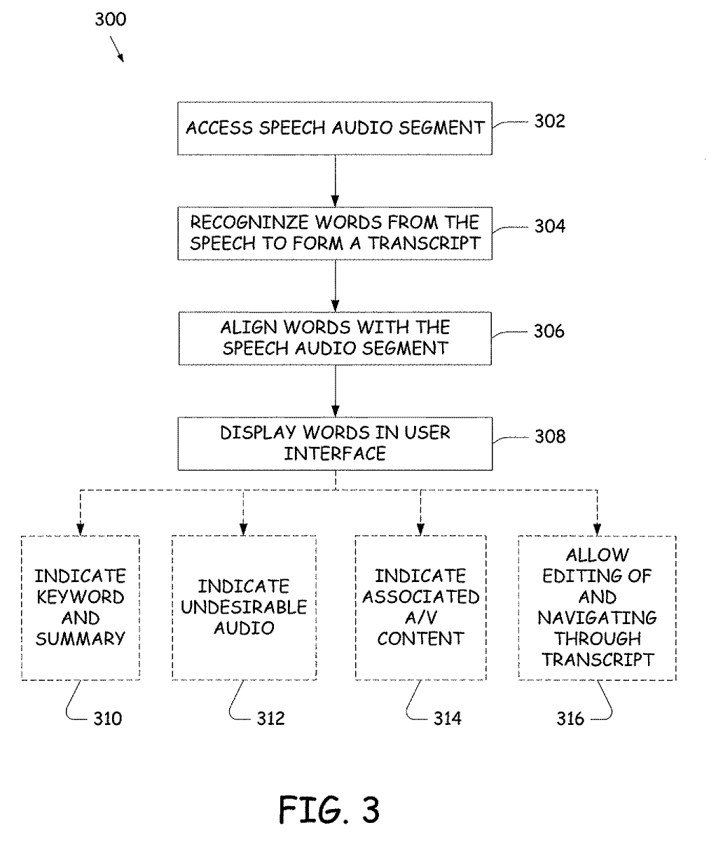

FIG. 3 is a flow diagram of a method 300 performed by system 100 to recognize and display words associated with A/V content 114. Method 300 begins at step 302 wherein a speech audio segment is accessed. The speech audio segment can be accessed from audio scene analyzer 108 as provided in method 200. At step 304, words from the speech are recognized by speech recognizer 110 to form a transcript of the audio segment. The words in the transcript are aligned with the speech audio segment at step 306. During alignment, word boundaries within the A/V content 114 are identified. At least a portion of the words are then displayed at step 308 in a user interface, such as user interface 106.

If desired, the user interface 106 can perform various tasks that allow a user to view, navigate and edit A/V content. For example, the user interface can indicate keywords and a summary at step 310, indicate undesirable audio at step 312, allow editing and navigating through the transcript at step 314 and display A/V content associated with the words at step 316. Undesirable audio can include various audio such as long pauses, vocalized noise, filled pauses such as um, ahh, uh, etc., repeats (“I think uh I think that”), false starts (e.g., “podcas-podcasting”), noise and/or profanity. Speech recognizer 110 can be used to flag and/or automatically delete this undesirable audio.

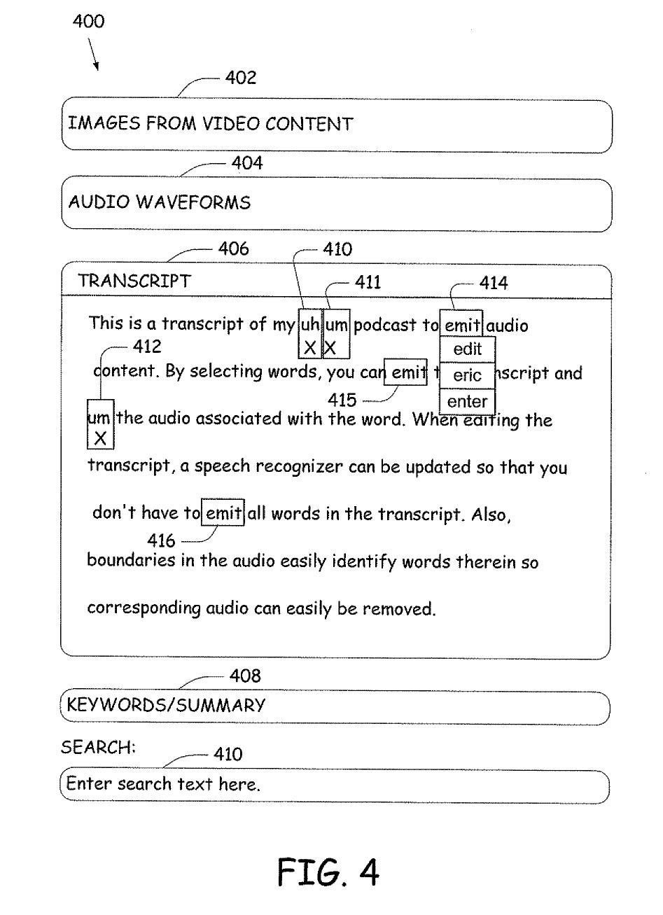

FIG. 4 is a user interface 400 for editing A/V content. User interface 400 includes images from video content 402, audio wave forms 404, transcript section 406, keywords/summary 408 and search bar 410. Images 402 and audio waveforms 404 correspond to portions of A/V content displayed in transcript section 406. A user, by editing words in transcript section 406, can alter images 402 as well as audio waveforms 404 automatically. More specifically, moving or deleting a sequence of contiguous words causes the associated A/V content to be moved or deleted through the use of the word time alignment against the A/V content.

Transcript section 406 provides several indications to aid in easily and efficiently editing A/V content. For example, transcript section 406 can indicate undesirable audio. Indications 410, 411 and 412 show undesirable audio, in this case indication 410 indicates the word “uh”, indication 411 indicates the word, “um” and indication 412 also indicates the word, “um”. Indications 410-412 also provide a deletion button, in this case in the form of an “x”. If a user selects the “x”, the corresponding word in the transcript is removed. Additionally, the corresponding audio and/or video is also removed from the A/V content.

Transcript section 406 also allows the user to selectively edit words contained therein. For example, a user can edit the words similar to a word processor or a user can selectively add and/or delete letters of words. Additionally, transcript section 406 can provide a list of potential words. As shown in list 414, transcript section 406 has recognized the word “emit”. However, it is apparent that the correct word should be “edit”. List 414 thus can be displayed, which includes further selections “edit”, “eric” and “enter”. By accessing list 414, user can select to have “edit” replace the word “emit”. After choosing to replace “emit” with “edit”, user interface 400 can indicate other instances where “emit” was recognized therein. For example, indications 415 and 416 indicate other instances of “emit” in the transcript. These words can be altered selectively, for example by automatically replacing all instances of “emit” with “edit” or a user can manually progress through each instance. The A/V content associated with a sequence of words can also be played back during the editing to ease the editing process by selecting a word sequence in the transcript and providing an indication to play the A/V content through the user interface.

Keyword/summary section 408 can also be updated as desired. For example, user can indicate other keywords and/or alter the summary of the transcript. Search bar 410 allows the user to enter text in which to navigate through the transcript. For example, a user can input a word that was said in a middle portion of an audio segment by utilizing search bar 410, transcript section 406 can automatically update to show the requested word and adjacent portions of the transcript of the word.

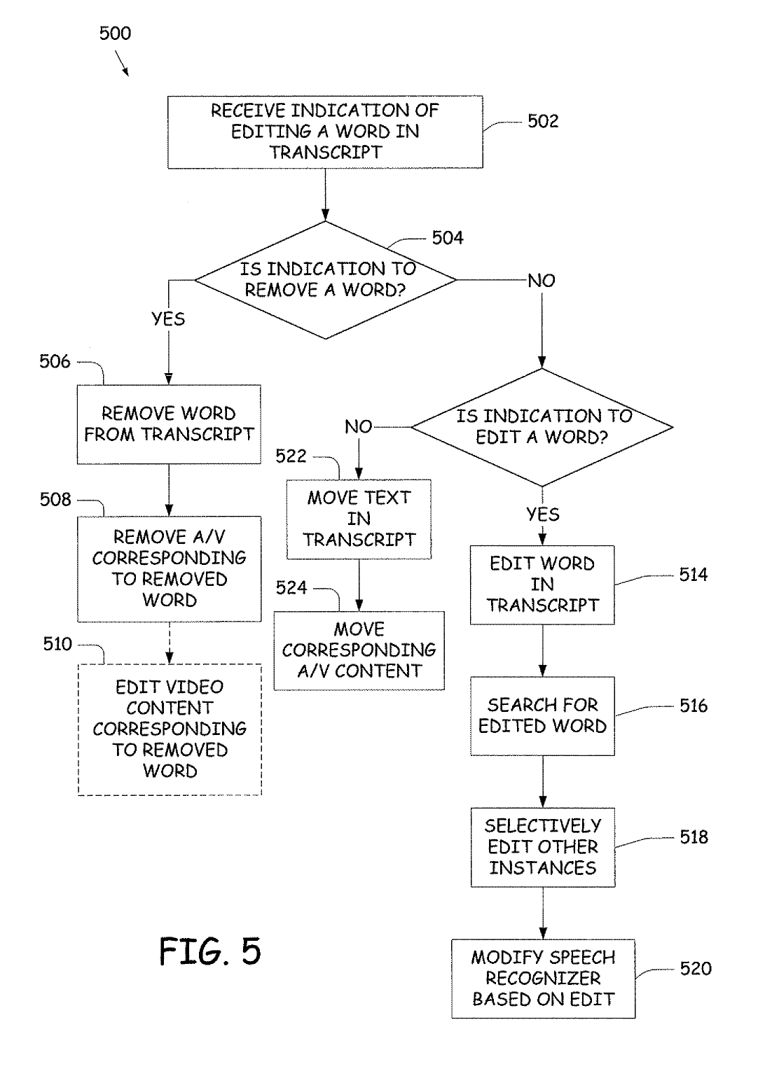

FIG. 5 is a flow diagram of a method 500 for editing media file 102 with editor 104 from user interface 106. At step 502, an indication of editing a word in a transcript is received. It is determined at step 504 whether the indication was to remove a word. If the indication is to remove a word, method 500 proceeds to step 506. At step 506, the word is removed from the transcript. Next, at step 508, A/V content corresponding to the removed word is also removed based on the alignment performed at step 306. If the removed content also includes video, the video can also be altered using various video editing techniques at step 510.

If the indication of step 502 is not to remove a word, method 500 proceeds from step 504 to step 512, where it is determined if a word was edited. The word in the transcript is edited at step 514. After editing the word in the transcript, method 500 proceeds to step 516 wherein the edited word is searched throughout the transcript. If one word is misrecognized by speech recognizer 110, it can be likely that other similar instances were misrecognized. At step 518, other instances of the word can selectively be edited. For example, the other instances can automatically be updated or other instances can be displayed to the user for manual editing. At step 520, the speech recognizer is modified based on the edit of the transcript. For example, after replacing the word “emit” with “edit”, speech recognizer 110 can be updated by altering one or more of the underlying feature extractor, acoustic model and language model.

If a word is not edited at step 512, the indication is to move text within the transcript, which occurs at step 522. For example, one section of text can be moved before or after another section of text. At step 524, the corresponding A/V content of the moved text is also moved. By using the underlying word boundaries in the A/V content, the A/V content can be moved.

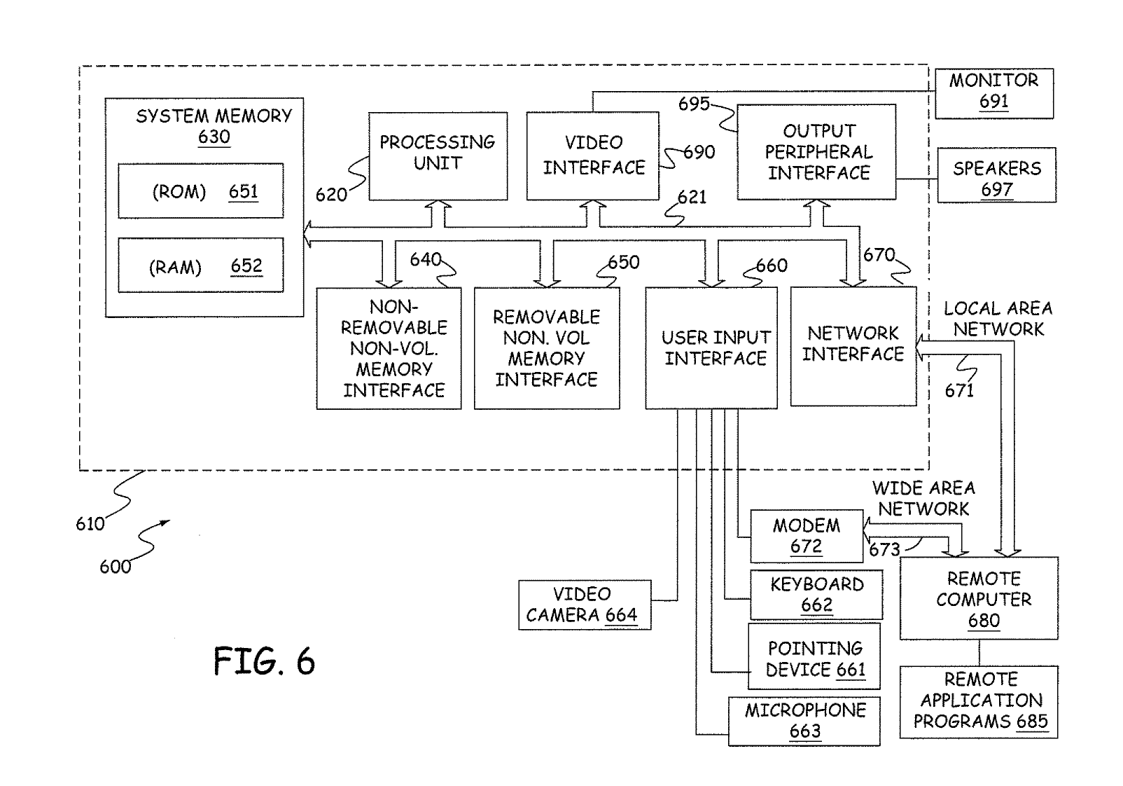

The above description of concepts relate to A/V content creation and editing. Using system 100, a user can create, edit and publish a media file for consumption across a network such as the Internet. Below is a suitable computing environment that can incorporate and benefit from these concepts. The computing environment shown in FIG. 6 is one such example that can be used to implement the A/V content editing system 100 and publish media file 102.

In FIG. 6, the computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary computing environment 600.

Computing environment 600 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Concepts presented herein may be described in the general context of computer-executable instructions, such as program modules, being executed by a computer. Generally, program modules include routines, programs, objects, components, data structures, etc. that perform particular tasks or implement particular abstract data types. For example, these modules include media file editor 104, user interface 106, audio scene analyzer 108, speech recognizer 110 and keyword/summary identifier 112. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 600 for implementing the above embodiments includes a general-purpose computing system or device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

The system memory 630 includes computer storage media in the form of volatile and/or nonvolatile memory such as read only memory (ROM) 631 and random access memory (RAM) 632. The computer 610 may also include other removable/non-removable volatile/nonvolatile computer storage media. Non-removable non-volatile storage media are typically connected to the system bus 621 through a non-removable memory interface such as interface 640. Removable non-volatile storage media are typically connected to the system bus 621 by a removable memory interface, such as interface 650.

A user may enter commands and information into the computer 610 through input devices such as a keyboard 662, a microphone 663, a pointing device 661, such as a mouse, trackball or touch pad, and a video camera 664. For example, these devices could be used to create A/V content 114 as well as perform tasks in editor 104. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690. In addition to the monitor, computer 610 may also include other peripheral output devices such as speakers 697, which may be connected through an output peripheral interface 695.

The computer 610, when implemented as a client device or as a service agent, is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. As an example, media file 102 can be sent to remote computer 680 to be published. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
accessing audio content that includes speech from at least one person;
recognizing words in the speech and converting the words to text;
displaying the text;
receiving an indication to modify the text that is displayed; and
modifying the audio content as a function of the indication.

2. The method of claim 1 and further comprising:
aligning the text with associated portions of the audio content and identifying word boundaries in the audio content based on the alignment.

3. The method of claim 2 wherein the indication is to remove text and wherein the audio is removed based on the word boundaries.

4. The method of claim 2 wherein the indication is to move text and wherein the audio is moved based on the indication and boundaries.

5. The method of claim 1 and further comprising:
automatically detecting undesirable audio in the audio content.

6. The method of claim 1 and further comprising:
receiving a search request indicative of a word in the text; and
displaying text and text adjacent thereto based on the search request.

7. The method of claim 1 and further comprising:
identifying pauses in the audio content and removing the pauses from the audio content.

8. The method of claim 1 and further comprising:
assembling the audio content and the text in a media file; and
publishing the media file across a computer network.

9. A method, comprising:
accessing audio content that includes speech from at least one person;
recognizing words in the speech and converting the words to text using a speech recognizer;
displaying the text
receiving an indication to edit the text that is displayed;
modifying other portions of the text as a function of the indication; and
editing the audio content as a function of the text.

10. The method of claim 9 and further comprising:
receiving a second indication to edit the text that is displayed; and
modifying the audio content as a function of the second indication.

11. The method of claim 9 and further comprising:
providing a list of potential words for a portion of speech in the audio content based on recognizing words.

12. The method of claim 9 and further comprising:
modifying the speech recognizer based on the indication.

13. The method of claim 9 and further comprising:
receiving a search request corresponding to a word; and
displaying the text and text adjacent to the word.

14. The method of claim 9 and further comprising:
detecting undesirable audio in the audio content.

15. The method of claim 9 and further comprising:
processing the text to identify a keyword and summary as a function of words in the text.

16. A system, comprising:
an audio scene analyzer adapted to access audio content and identify speech contained therein;
a speech recognizer adapted to receive the speech and recognize words from the speech and output a transcript indicative thereof;
a user interface adapted to display the text and receive an indication of modifying the text; and
an editor adapted to receive the indication and edit the audio content based on the indication.

17. The system of claim 16 wherein the speech recognizer is further adapted to identify word boundaries in the speech and align the transcript with the word boundaries.

18. The system of claim 16 wherein the user interface is adapted to display video content and audio waveforms associated with the audio content.

19. The system of claim 16 wherein the editor is adapted to assemble the audio content and transcript into a media file.

20. The system of claim 16 wherein the audio scene analyzer is adapted to separate the speech into multiple speech segments that are processed by the speech recognizer in parallel using multiple processing elements.
